(19) United States
(12) Patent Application Publication
(10) Pub. No.: US 2015/0113878 A1
(43) Pub. Date: Apr. 30, 2015

(54) REPLACEMENT FOR CABINET DOOR WITH PET DOOR OPENING AND LITTER CONTAINMENT SYSTEM

(71) Applicants: David SWARD, Gilroy, CA (US); Karla SWARD, Gilroy, CA (US)

(72) Inventors: David SWARD, Gilroy, CA (US); Karla SWARD, Gilroy, CA (US)

(21) Appl. No.: 14/527,045

(22) Filed: Oct. 29, 2014

Related U.S. Application Data
(60) Provisional application No. 61/897,164, filed on Oct. 29, 2013.

(51) Int. Cl. E06B 7/32; A01K 1/01; E06B 11/02

(52) U.S. Cl. CPC E06B 7/32; E06B 11/02; A01K 1/01
USPC 49/63; 49/464; 49/70; 49/506

(57) ABSTRACT

A product includes a panel that can be used in place of a door in a cabinet. The dimensions of the panel are such that it covers the opening in the cabinet that was covered by the cabinet door. A pet door (e.g., an opening with a moveable flap or cover) is installed in a precut opening in the panel. A litter containment system (which includes a litter box or something else of similar purpose) can be placed inside the cabinet. A pet (e.g., a household pet such as a cat or dog) can reach the litter box or the like through the pet door. The panel includes features that allow it to be readily installed, removed, and re-installed, so that the pet owner can easily reach, remove, empty/clean, and replace a litter box or the like that is inside the cabinet.

### CROSS-REFERENCE TO RELATED APPLICATION

This application claims priority to the U.S. Provisional application filed on Oct. 29, 2013, entitled “Cabinet Replacement Door with Pet Door Opening and Litter Containment System,” Ser. No. 61/897,164, and hereby incorporated by reference in its entirety.

### BACKGROUND

Litter boxes for pets such as cats and dogs are found in many households. A problem with common litter boxes is that the litter they are supposed to contain often falls or is carried out of the litter box onto the surrounding flooring, and so pet owners have to frequently clean (e.g., sweep or vacuum) the area around the litter box. This problem can occur even if a hood or cover is in place on top of the litter box.

Also, common litter boxes are usually unsightly and malodorous. However, even though pet owners in general would prefer not being confronted with the sight and smell, litter boxes are often left out in the open because pets have to be able to access them and/or because pet owners do not have a better place to put them.

A litter box can be particularly problematic for a pet owner living in a smaller apartment or a home with a small bathroom or laundry room in which the litter box is placed. In such small areas, the litter box essentially takes over the entire room, rendering it unusable for other purposes unless it is cleaned beforehand.

### SUMMARY

Thus, a product that conveniently and elegantly addresses the problems mentioned above would be useful. Embodiments according to the present invention provide such a product.

In general, embodiments according to the present invention include a panel that can be used to replace a door in, for example, an existing, installed cabinet. That is, an existing cabinet door can be removed and the panel put in its place. The panel can be manufactured with and/or decorated with material that matches or complements the cabinet material.

The dimensions of the panel are such that it covers and encloses an opening in the cabinet that would normally be covered by the cabinet door. Panels can be fabricated in different standard sizes to accommodate different sizes of openings. In an embodiment, as an alternative to fixed-size panels, panels can include features that allow them to be expanded or reduced in size so that they can be readily adapted to cover different sizes of openings.

A pet door (e.g., an opening with a moveable flap or cover) can be installed in an opening in the panel. A “litter containment system” (which includes a litter box or something else of similar purpose) can be placed inside the cabinet. A pet (e.g., a household pet such as a cat or dog) can reach the litter box or the like through the pet door. In such fashion, the interior of the cabinet can house and contain the litter box, thereby freeing up room space that would otherwise be occupied by the litter box.

The panel includes features that allow it to be readily attached to a cabinet, then removed and reattached, so that the pet owner can easily reach, remove, empty/clean, and replace a litter box or the like that is inside the cabinet, and can also readily clean the inside of the cabinet. In an embodiment, one or more (first) fastening elements on the panel can be detachably fastened to one or more corresponding (second) fastening elements located inside the cabinet. For example, one or more magnets can be mounted on the panel and one or more metal plates can be mounted inside the cabinet opening; each magnet and each metal plate are mounted in a particular position such that, when a magnet on the panel is attached to the corresponding metal plate inside the opening, the panel is properly aligned over the opening. Alternatively, one or more metal plates can be installed on the panel, and one or more magnets can be installed inside the cabinet. The sets of magnets and metal plates hold the panel in place but allow it to be easily removed. Other types of fastening elements can be used instead of magnets and metal plates.

In an embodiment, the second fastening element(s) can be mounted on one or more mounting elements (e.g., brackets) that are in turn attached inside the opening in the cabinet. The position of a fastening element on a mounting element matches with the position of a fastening element on the panel, thereby facilitating the initial installation of the product. In other words, for example, metal plates can be pre-installed on a mounting element in positions so that, when the mounting element is installed inside the opening and then the panel is properly positioned against the cabinet, each magnet on the panel will be automatically aligned with and will be in contact with a corresponding metal plate on the mounting element. Thus, the use of one or more mounting elements eliminates the need to make detailed measurements in order to properly align the panel when installing the panel for the first time. Consequently, a person with little or no experience in making household improvements can install the panel without difficulty.

In an embodiment, a support piece at or near the bottom of the inside of the panel rests against a surface that is inside the cabinet when the panel is installed in place over the opening. The support piece can include, for example, a lip that fits with a rail that is mounted on a surface inside the cabinet. The support piece and the lip help align the panel with the opening and also help hold the panel in place. The support piece and/or rail also can serve as a barrier to help prevent moisture and litter, for example, from leaking out of the cabinet.

In an embodiment, in addition to a litter box or the like, the litter containment system includes an insert that fits within the opening in the cabinet. The insert can include a bottom, sidewalls, and possibly a top, but is open toward the opening in the cabinet when it is installed in place inside the cabinet. The insert helps protect the inside of the cabinet against litter and any mess and buildup. In such an embodiment, the aforementioned rail can be pre-mounted on the bottom of the insert. Also, the one or more second fastening elements that are mentioned above can be attached to the insert, positioned to align with one or more corresponding first fastening elements on the panel, thereby facilitating installation as described above and eliminating the need to install the mounting element(s) also mentioned above.

In an embodiment, the insert is movably attached inside the cabinet, so that it can be easily moved in and out of the cabinet. For example, the insert may be mounted on sliding hardware (like those used for drawers) or on rollers. In an embodiment, the insert includes a moveable tray or shelf on which the litter box or the like is placed; thus, the tray or shelf and consequently the litter box can be moved in and out of the insert and cabinet. In these embodiments, by sliding the insert and/or tray or shelf holding the litter box out of the cabinet, the pet owner can easily reach, remove, empty/clean, and replace the litter box or the like, and can easily clean the insert itself.

In an embodiment, the product includes a sensor. For example, the sensor may be an electric eye or photodetector mounted within sight of the pet door, or it may be some type of device that is attached to the flap on the pet door. In general, the sensor can count the number of times a pet passes through the pet door and can transmit the count, or an alert based on the count, to another device such as a smartphone. In this manner, a pet owner can conveniently monitor the number of times the litter box or the like is used and can determine whether or not it might be necessary to empty/clean it.

In summary, embodiments according to the present invention provide a convenient and elegant product that helps contain pet litter, reducing the amount of time that pet owners need to spend cleaning up around the litter box. Also, the litter box or the like is out of sight and odors are contained. However, the litter box or the like remains readily accessible to household pets, and is also readily accessible to pet owners for maintenance and cleaning.

The present invention product—e.g., a panel with or without an insert—can be used in places such as, but not limited to, houses, apartments, and recreational vehicles (RVs). The product can be retrofitted into existing cabinets after they have been installed in a home or RV, for example, or can be installed in new cabinets while they are being fabricated.

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure. The figures are not necessarily drawn to scale.

FIG. 1A illustrates a front view of a panel in an embodiment according to the present invention.

FIG. 1B illustrates a front view of a panel in another embodiment according to the present invention.

FIG. 1C illustrates a panel and a cabinet in an embodiment according to the present invention.

FIG. 2 illustrates a back view of a panel in an embodiment according to the present invention.

FIG. 3A illustrates a side (cross-sectional) view of a panel in an embodiment according to the present invention.

FIG. 3B illustrates a side (cross-sectional) view of a panel in another embodiment according to the present invention.

FIG. 4A illustrates a side (cross-sectional) view of a panel and a mounting bracket in an embodiment according to the present invention.

FIG. 4B illustrates mounting brackets installed on each side of a cabinet opening in an embodiment according to the present invention.

FIG. 4C illustrates a top-down (cross-sectional) view of a mounting bracket in an embodiment according to the present invention.

FIG. 4D illustrates mounting brackets incorporating a rail that is installed in a cabinet opening in an embodiment according to the present invention.

FIG. 5A illustrates an insert in an embodiment according to the present invention.

FIG. 5B illustrates an insert in another embodiment according to the present invention.

FIG. 6 is a flowchart of an example of a method for fabricating a panel in an embodiment according to the present invention.

FIG. 7 is a flowchart of an example of a method for maintaining a litter box containment system in an embodiment according to the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known components have not been described in detail so as not to unnecessarily obscure aspects of the present disclosure.

In overview, as presented above and described in more detail below, embodiments according to the invention pertain to a product that includes a panel that can be used in place of a door in a cabinet. The dimensions of the panel are such that it covers an opening in the cabinet that would normally be covered by a cabinet door. A pet door (e.g., an opening with a moveable flap or cover) can be installed in an opening in the panel. A “litter containment system” (which includes a litter box or something else of similar purpose) can be placed inside the cabinet. A pet (e.g., a household pet such as a cat or dog) can reach the litter box or the like through the pet door. The panel includes features that allow it to be readily installed, removed, and re-installed, so that the pet owner can easily reach, remove, empty/clean, and replace a litter box or the like that is inside the cabinet, and can also readily clean the inside of the cabinet. In this fashion, the interior of the cabinet can house and contain the litter box, thereby freeing up room space that would otherwise be occupied by the litter box. The litter box and any mess associated with it would be contained within a relatively small part of the room, within an existing cabinet and isolated from someone that wanted to use the room. This can be especially important in, for example, a smaller apartment or room or in a RV, where space is somewhat limited.

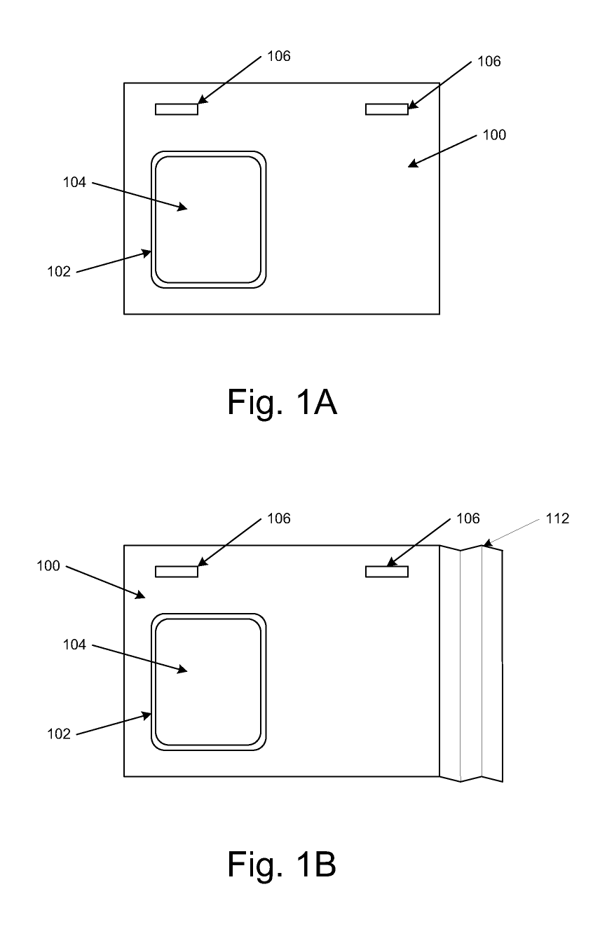

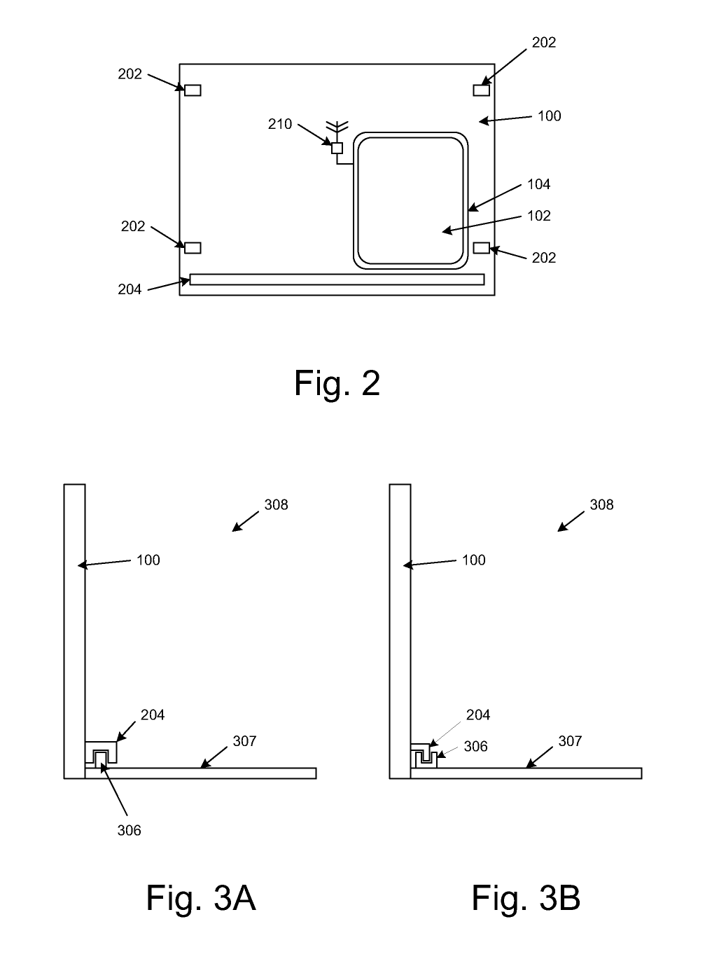

FIG. 1A illustrates the outside surface of a panel 100 in an embodiment according to the present invention. In the example of FIG. 1A, “outside” refers to the side of the panel 100 that faces outward relative to a cabinet when the panel is attached to the cabinet (see FIG. 3A, for example).

The panel 100 of FIG. 1A includes an opening 102. A pet door—in general, a moveable flap or cover 104 that is typically hinged at the top or side—is installed in and integrated with the panel 100. In an embodiment, the panel 100 includes one or more handles 106.

In use, the panel 100 is attached to a cabinet 108 instead of or as a replacement for a cabinet door, as shown in FIG. 1C. For example, during fabrication, the panel 100 can be installed in a new cabinet instead of a cabinet door. In an existing, installed cabinet, a cabinet door can be removed and replaced with the panel 100. In either case, the dimensions of the panel 100 are such that it covers the opening in the cabinet normally covered by a cabinet door. The panel 100 can be manufactured in different sizes to accommodate different sizes of openings. A customer can select from different standard sizes, or can custom-order a panel having particular dimensions.

The panel 100 can be made of plastic, wood, or some other suitable material. A customer can select from different standard materials and different standard appearances, or can custom-order a panel made of a particular material (e.g., wood, plastic, laminates, etc.) and/or having a particular appearance (for example, an appearance that matches the customer's existing cabinets). The panel 100 can also be customized with decorations of the customer's choosing, such as pictures (e.g., a picture of a pet or pets) or other artistic concepts, or with decorations associated with other types of products (e.g., pet-related products). Similarly, the handles 106 can be standard handles, or they can be custom-ordered to match the handles on existing cabinets.

In an embodiment, the height and/or width of the panel 100 can be increased or decreased using one or more moveable, expandable, or contractible elements 112, such as but not limited to a sliding panel or an accordion-like part, located along one or more of the edges of the panel 100 as shown in the example of FIG. 1B.

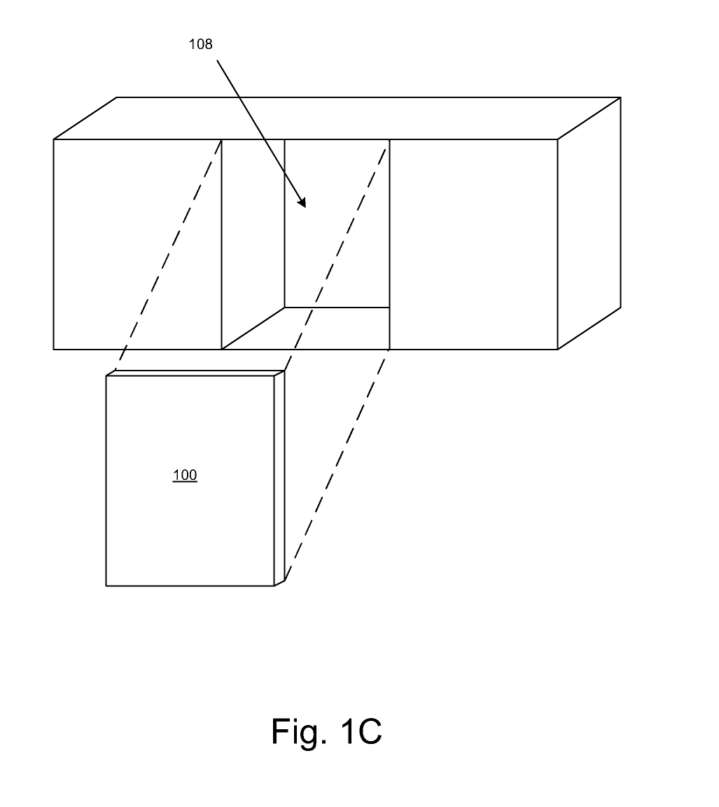

FIG. 2 illustrates a view of the inside surface of the panel 100 (the side that faces toward the cabinet when the panel is attached to the cabinet). In the example of FIG. 2, one or more fastening elements 202 (which may be referred to herein as first fastening elements) are attached to the panel 100. Various types of fasteners can be used. For example, the fastening elements 202 may be magnets (which can be attached to metal plates that are mounted inside the cabinet), or they may be metal plates (which can be attached to magnets that are mounted inside the cabinet), or they may be a combination of different types of fasteners. Generally speaking, the fastening elements 202 are of a type that allows the panel 100 to be readily attached to and detached from a cabinet. In an embodiment, in addition to the fastening elements, one or more latches or the like are included on the panel 100 and/or on the cabinet, to help hold the panel in place over the cabinet opening. In general, such latches or the like can be used when the panel is used, for example, in an RV in order to help hold the panel in place and keep it from detaching from the cabinet if the RV is driven over a bump in the road, etc.

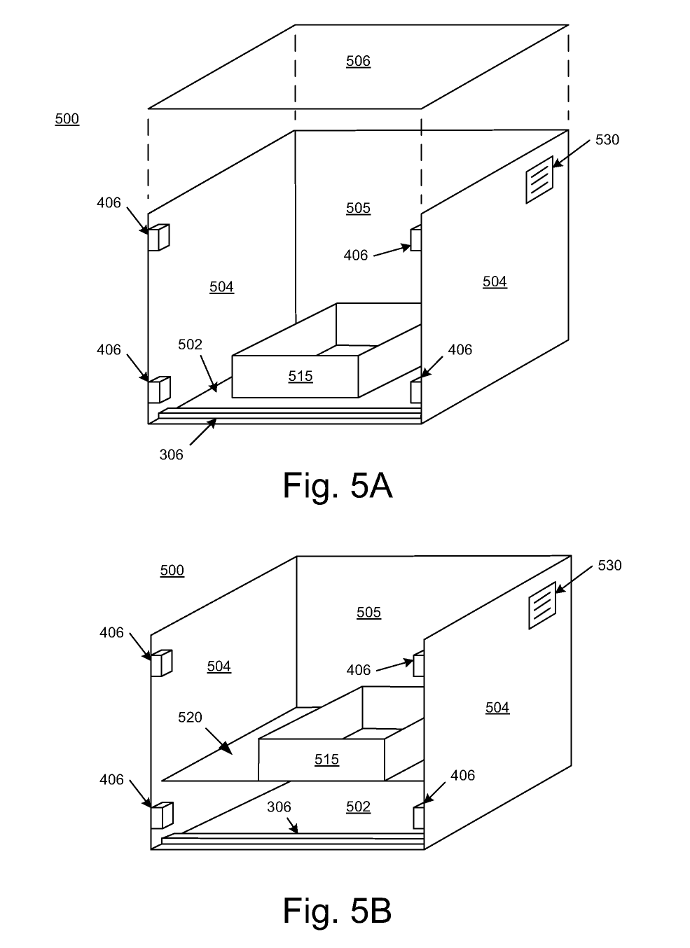

In an embodiment, a support piece 204 is mounted along the lower portion of the inside of the panel 100. The support piece 204 rests against a surface inside the cabinet (e.g., the bottom shelf of the cabinet) when the panel 100 is installed in place against the cabinet. In such an embodiment, the support piece 204 includes a lip that fits with a rail 306 that is mounted on a surface 307 inside a cabinet 308, as shown in FIGS. 3A and 3B. The surface 307 can be the bottom/floor of the cabinet opening; in an embodiment, the surface 307 can be the bottom surface of an insert (see FIG. 5A, for example). In the example of FIG. 3A, the lip of the support piece fits over and around the rail 306. In the example of FIG. 3B, the lip of the support piece 204 fits into a slot in the rail 306.

The lip and the rail 306 may extend all the way or part of the way across the surface 307. The lip and the rail 306 help align the panel 100 with the cabinet when the panel is being attached over the opening in the cabinet; essentially, the lip can be properly positioned on the rail, and then the panel can be pivoted into place. The support piece 204 and the rail 306, alone or together, can also serve as a barrier to help prevent litter and/or moisture from escaping from inside the cabinet. A specially designed litter box can also be used in place of or in combination with the support piece and rail to help prevent litter and/or moisture from escaping from inside the cabinet. Also, a waterproof (e.g., rubber or plastic) sheet that is cut to fit the bottom of the cabinet can be used with the panel 100 to help contain and/or protect against any leakage.

With reference to FIG. 2, in an embodiment, a sensor 210 is mounted on the inside surface of the panel 100. In general, the sensor 210 is mounted in a position in communication with the pet door 102/104. For example, the sensor 210 may be an electric eye or photodetector mounted in line-of-sight of the pet door 102/104. Alternatively, the sensor 210 may be attached physically to the flap 104 and pet door 102, in a manner that causes the sensor to be triggered when the flap is moved by a pet passing through the pet door, for example. As another alternative, a pet can wear a device (e.g., a radio frequency identifier (RFID) device that is integrated with or clipped onto the pet's collar) that is detected by the sensor 210 each time the pet passes through the pet door 102; each device can have its own ID so that, when there are multiple pets, the number of times each pet uses the litter box can be counted (a count per pet). The sensor 210 counts the number of times a pet passes through the pet door 102 and can transmit (e.g., wirelessly transmit) the count, or an alert based on the count, to another device such as a smartphone. A display that displays the count could also be included on the pet door or on the panel. In this manner, a pet owner can conveniently monitor the number of times the litter box or the like is used, in order to decide whether or not it might be time to empty and/or clean it. In a case in which each pet wears a device with a unique ID per pet, a pet owner can monitor the number of times each pet uses the litter box as well as total usage.

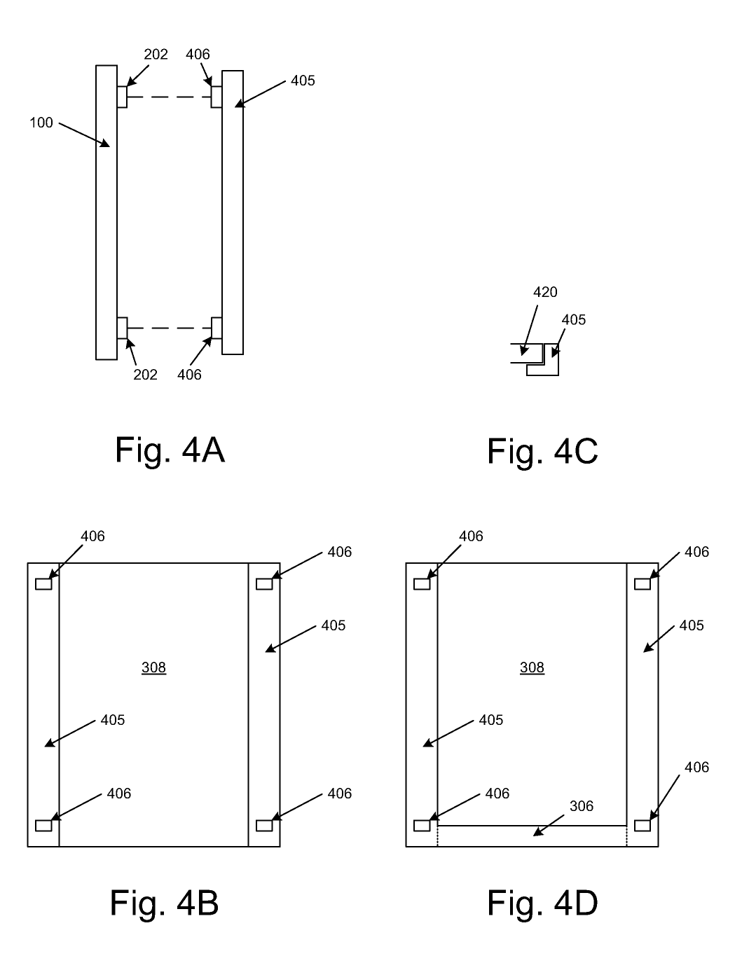

FIG. 4A illustrates a side view of the panel 100 and a mounting element 405 in an embodiment according to the present invention. In one such embodiment, a mounting element 405 can be installed on one side of the opening in the cabinet 308, and another such mounting element can be installed on the other side of the opening in the cabinet, as shown in the example of FIG. 4B. In an embodiment, the mounting element 405 is an L-shaped bracket that can be mounted along a vertical edge or corner 420 of the cabinet opening; a top view of this is shown in FIG. 4C. The mounting element 405 can include predrilled holes to facilitate installation. The mounting element 405 can be expandable to accommodate different sizes of cabinet openings.

FIG. 4D illustrates mounting brackets 405 incorporating a rail 306 and that is installed along the sides and bottom of an opening in a cabinet 308 in an embodiment according to the present invention. More specifically, the mounting brackets 405 and the rail 306 are formed as a single part (essentially, a part shaped like a squared-U) that fits on both sides and along the bottom of the cabinet opening. In an embodiment, the mounting brackets 405 and/or the rail 306 are expandable, to more easily accommodate different sizes of cabinet openings. Preconfigured arrangements and combinations of mounting hardware other than those specifically described herein can be conceived of and manufactured.

With reference to FIGS. 4A, 4B, and 4D, each mounting element 405 includes one or more fastening elements 406 (which may be referred to herein as second fastening elements). Various types of fasteners can be used. Generally speaking, the fastening elements 406 are of a type that allows the panel 100 to be readily attached to and detached from the cabinet. For example, with reference to FIGS. 1A and 4A, the fastening elements 406 may be magnets (which can be attached to the fastening elements 202; e.g., metal plates, on the panel 100), or they may be metal plates (which can be attached to the fastening elements 202; e.g., magnets, on the panel 100), or they may be a combination of different types of fasteners.

Significantly, the fastening elements 406 can be pre-installed on a mounting element 405 at particular positions so that, when the mounting element is installed inside the cabinet, the fastening elements 406 will be automatically aligned with the fastening elements 202 on the panel 100 when the panel is properly positioned against the cabinet. Thus, it is not necessary to make detailed measurements in order to align the fastening elements on the panel and the fastening elements inside the cabinet for proper installation. Consequently, a person with little or no experience or training can readily install the panel 100 in a manner so that it is properly aligned with and over the opening in the cabinet.

FIG. 5A illustrates an insert 500 that can be a part of the litter containment system in embodiments according to the present invention. In other words, an embodiment according to the present invention includes only the panel; another embodiment according to the present invention includes only the insert; and yet another embodiment according to the present invention includes both the panel and the insert. The insert 500 fits within an opening in the cabinet (the opening shown in FIG. 1C). Different sizes of inserts can be fabricated to accommodate different sizes in cabinet openings. A customer can select from different standard sizes, or can custom-order a panel having particular dimensions. The insert 500 is useful for containing the spread of litter and facilitates cleanup.

Continuing with reference to FIG. 5A, the insert 500 can include a bottom 502, sidewalls 504, and back 505. In one embodiment, the insert 500 also includes a top 506. In an embodiment, the insert 500 is made of any suitable material that, in general, is easy to clean and lightweight (e.g., plastic).

The bottom 502, sidewalls 504, and back 505, and optionally the top 506, can be fabricated as an integrated unit. Alternatively, they can be fabricated as individual components that are installed in the cabinet opening as separate pieces, or that are subsequently assembled and then installed in the opening as a unit.

When properly installed, the open side of the insert 500 faces toward the opening in the cabinet. In an embodiment, the insert 500 is fixed inside the cabinet opening. For example, the insert 500 can be attached with screws to the inside of the cabinet. In another embodiment, the insert 500 is movably attached inside the cabinet, so that it can be easily moved in and out of the cabinet. For example, the insert 500 may be mounted on sliding hardware (like those used for drawers) or on rollers. Alternatively, the insert 500 may be simply placed inside the cabinet opening and held in place by its own weight. A litter box 515 or the like can be placed on the bottom 502 of the insert 500. In an embodiment, the insert 500 can include a shelf (not shown) that is attached to the insert and upon which the litter box can be placed (that is, the shelf is stationary within the insert).

With reference to FIG. 5B, in another embodiment, the insert 500 includes a moveable tray or shelf 520 on which the litter box 515 or the like is placed; that is, the tray or shelf can be moved independently of the insert. In the FIG. 5B embodiment, the insert 500 may be attached to the cabinet or it may be movably attached inside the cabinet as described above. The tray or shelf 520 can be mounted on sliding hardware so that it can be moved in and out of the cabinet/insert, or the tray or shelf can be mounted in slots or sleeves that are attached to or integrated with the sidewalls 504. In general, the tray or shelf 520 is mounted in such a way that it is protected against the spread of litter from the litter box 515 or the like, so that the litter will not cause binding of the tray or shelf and interfere with its movement.

The insert 500 helps protect the inside of the cabinet against litter. Cleaning is also facilitated. For example, in the embodiments just described, the pet owner can easily reach, remove, empty/clean, and replace a litter box 515 or the like that is inside the cabinet by sliding the insert 500 and/or the tray or shelf 520 out of the cabinet. Furthermore, in an embodiment in which the insert 500 is made of a relatively easy-to-clean and reusable material (e.g., plastic), the insert itself can be removed, cleaned, and reinserted. Thus, the insert 500 can be reusable, and can be replaced with another insert at any time. In an embodiment, instead of using a relatively lightweight and easy to clean material such as plastic for the insert 500, it can be made of a relatively inexpensive material such as cardboard that can be replaced as often as desired for relatively low cost. Replacement inserts could be provided as a service for a fee on a periodic (e.g., monthly) basis.

Also, regardless of and in addition to the material of which it is made, the insert 500 can be lined with a disposable liner element of some sort (e.g., wax paper or plastic film) that can be readily removed or replaced after multiple uses or a single use. The liner element may be a single layer (a single liner) or multiple layers (multiple liners). In the former case, the liner element can be removed and replaced with another liner element; in the latter case, the top-layer liner can be removed to expose another liner that is underneath, and so on until all liners are used, at which time another liner element can be installed.

The rail 306 described in conjunction with FIGS. 3A and 3B can be attached to (e.g., pre-mounted in) the insert 500 instead of being attached to the surface of the cabinet. This can facilitate installation, because it is not necessary to separately install such a rail. Also, the second fastening element(s) 406 (e.g., one or metal plates) can be attached to the insert 500, positioned to align with corresponding first fastening element(s) 202 (e.g., one or more magnets; FIG. 2) on the panel 100, thereby facilitating installation and also eliminating the need for the mounting element(s) 405 of FIG. 4A.

The sidewalls 504 and back 505 of the insert 500 of FIGS. 5A and 5B do not necessarily have to reach the top of the cabinet opening. Instead, they can extend only partway up the sides and back of the opening, to a height that satisfactorily protects the inside of the cabinet against any litter that escapes from the litter box 515 (e.g., to a height of about 18 inches). Also, the sidewalls 504 and back 505 can have different dimensions; for example, the back can be shorter than the sidewalls. In each of these cases, installation of the insert 500 inside the opening is facilitated because interference between the insert and items within the opening (e.g., plumbing) is avoided or minimized.

In an embodiment, the sidewalls 504 and/or back 505 of the insert 500 can include standard or custom-order precut openings and/or contours that allow the insert to fit around items within the cabinet opening, such as plumbing. Alternatively, the sidewalls 504 and/or back 505 can include a variety of different perforations that allow a person to create openings and contours in the insert 500 where they are needed.

In an embodiment, the insert 500 includes an opening (e.g., a vent 530) and associated hardware (not shown) that allows the litter containment system to be vented to, for example, an exhaust system that leads outside the home. Many homes include an exhaust system for a clothes dryer that can be tapped into and used as the exhaust system for the litter containment system. The associated hardware can include, for example, ducting, connecting hardware, and a fan that draws air from inside the insert 500 into the exhaust system. If the dryer's exhaust system is used, the hardware can also include backflow valves or the like to ensure that air will flow in the correct direction and does not enter the dryer.

A number of different accessories (not shown) can be included with or purchased separately from the insert 500. For example, a light that turns on when the pet enters through the pet door can be included or purchased separately. Also, the insert 500 can include an integrated container that can hold a replaceable charcoal filter or the like for absorbing or masking odors. The insert 500 can include one or more hooks or some other type of mechanism for storing related accessories such as scoops. These types of accessories can be used even if the insert 500 is not used. In other words, these types of accessories can be used inside the cabinet even if the insert 500 is not present.

Also, as mentioned above, the insert 500 can be lined with a layer or layers of material such as plastic or paper that can be removed one layer at a time to facilitate cleaning. For example, a plastic bag or tent in the same general shape as the insert 500 can be secured (e.g., with an adhesive or tape) inside the insert, used for a period of time, then removed either to expose a new layer or to be replaced with a new liner. A mat or the like can be included for the purpose of cleaning the pet's paws after it exits the litter box but before it exits through the pet door 102/104 (FIG. 1A). As mentioned above, these types of accessories can be used even if the insert 500 is not used. In other words, even if only the panel 100 is used, these types of accessories can be used inside of the cabinet even if the insert 500 is not present.

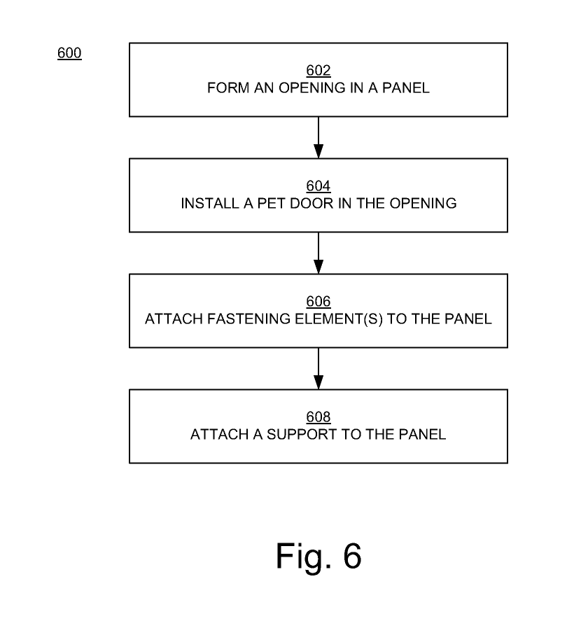

FIG. 6 is a flowchart 600 of an example of a method for fabricating a panel (e.g., the panel 100 of FIG. 1A) in an embodiment according to the present invention. The fabrication processes and steps described below may be performed along with the processes and steps discussed herein; that is, there may be a number of process steps before, in between and/or after the steps shown and described herein. Importantly, embodiments in accordance with the present invention can be implemented in conjunction with these other (perhaps conventional) structures, processes and steps without significantly perturbing them. Generally speaking, embodiments in accordance with the present invention can replace portions of a process without significantly affecting peripheral structures, processes and steps.

In block 602 of FIG. 6, an opening is formed in a panel (e.g., the opening 102 of FIG. 1A). In an embodiment, the panel is for a cabinet; for example, it can be used in place of a cabinet door.

In block 604 of FIG. 6, a pet door (e.g., the pet door 104 of FIG. 6) is installed in the opening in the panel.

In block 606 of FIG. 6, one or more fastening elements (e.g., the fastening elements 202 of FIG. 2) are attached to the panel in a specific position on the panel. The fastening element(s) can be attached to and detached from a corresponding fastening element (e.g., a fastening element 406 of FIG. 4A) that is inside a cabinet.

In block 608 of FIG. 6, a support (e.g., the support piece 204 of FIG. 2) is attached to a bottom portion of the panel. In an embodiment, other elements are also attached to the panel. For example, a sensor 210 (FIG. 2) can be attached to the panel.

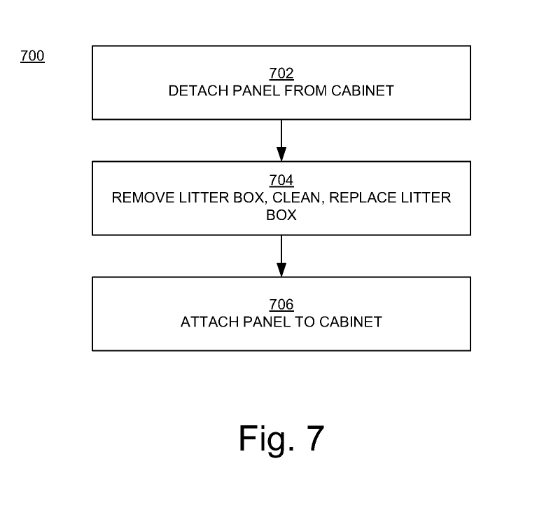

FIG. 7 is a flowchart 700 of an example of a method for maintaining a litter box containment system in an embodiment according to the present invention. As described above, a panel (e.g., the panel 100 of FIG. 1A) is installed over an opening in a cabinet and litter box containment system (which may include an insert and a litter box) is placed inside the cabinet.

In block 702, to access the litter box, for example, the panel is detached from the cabinetry. As mentioned above, the panel is attached to the cabinetry using fastening elements such as magnets and so can be readily detached and removed to permit easy access to the interior of the cabinet and its contents.

In block 704, the litter box can be removed, emptied and cleaned, and replaced. The inside of the cabinet can also be readily cleaned. If an insert is used, it can be readily accessed and cleaned as described above, or easily removed, cleaned, and replaced.

In block 706, the panel is replaced over the cabinet opening and reattached using the fastening elements, as described above.

In summary, embodiments according to the present invention provide a convenient and elegant product (a panel and optionally an insert) that helps contain pet litter, reducing the amount of time that pet owners need to spend cleaning up the area around a litter box. Also, the litter box or the like is out of sight and odors are contained. However, the litter box or the like remains readily accessible to household pets.

The product can be sold as a stand-alone product or through strategic partnerships with, for example, cabinetmakers, home builders, RV manufacturers, paper product manufacturers and sellers, etc.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A product comprising:
a panel;
a pet door installed in the panel; and
a fastening element coupled to the panel and that is detachably fastened to a corresponding fastening element that is inside a cabinet with the panel installed in place over an opening in the cabinet;
the panel further comprising a support coupled to a bottom portion of the panel and that rests against a surface that is inside the cabinet with the panel installed in place over the opening.

2. The product of claim 1, wherein the support comprises a lip that fits with a rail that is mounted on the surface inside the cabinet.

3. The product of claim 1, further comprising an insert that fits within the opening, the insert comprising a bottom and a sidewall coupled to the bottom, the insert open toward the opening in the cabinet when installed in place inside the cabinet.

4. The product of claim 3, wherein the insert further comprises a top coupled to the sidewall.

5. The product of claim 3, wherein the insert further comprises a removable liner.

6. The product of claim 3, wherein the support comprises a lip that fits with a ridge on the bottom of the insert.

7. The product of claim 3, wherein the insert comprises a vent.

8. The product of claim 3, wherein the insert is moveably attached to the cabinet.

9. The product of claim 3, wherein the insert comprises a moveable shelf.

10. The product of claim 1, wherein the panel is expandable.

11. The product of claim 1, further comprising a sensor operable for counting passages through the pet door and for transmitting a count of the passages to another device.

12. The product of claim 1, further comprising a mounting element comprising the corresponding fastening element.

13. A product comprising:
a panel;
a pet door installed in the panel; and
an insert removably coupled to the panel, the insert comprising a bottom and a sidewall coupled to the bottom.

14. The product of claim 13, further comprising:
a fastening element coupled to the panel and that is detachably fastened to a corresponding fastening element inside a cabinet with the panel installed in place over an opening in the cabinet; and
a support coupled to a bottom portion of the panel and that rests against a surface inside the cabinet with the panel installed in place over the opening.

15. The product of claim 14, wherein the support comprises a lip that fits with a rail that is mounted on the surface inside the cabinet.

16. The product of claim 14, further comprising a mounting element comprising the corresponding fastener.

17. The product of claim 13, wherein the insert further comprises a removable liner.

18. The product of claim 13, wherein the support comprises a lip that fits with a ridge on the bottom of the insert.

19. The product of claim 13, wherein the insert comprises a moveable shelf.

20. The product of claim 13, wherein the panel is expandable.

21. The product of claim 13, further comprising a sensor operable for counting passages through the pet door and for transmitting a count of the passages to another device.

22. A method comprising:
forming an opening in a panel;
installing a pet door in the opening in the panel;
attaching a fastening element to the panel in a specific position on the panel, the fastening element configured to be attachable to and detachable from a corresponding fastening element that is inside a cabinet; and
attaching a support parallel to a bottom portion of the panel.
